(19) United States
(12) Patent Application Publication
(10) Pub. No.: US 2024/0416910 A1
(43) Pub. Date: Dec. 19, 2024

(54) CRUISE CONTROLLER

(71) Applicant: VOLVO TRUCK CORPORATION, Göteborg (SE)

(72) Inventors: Oscar STJERNBERG, Göteborg (SE); Martin Wilhelmsson, Torslanda (SE)

(73) Assignee: VOLVO TRUCK CORPORATION, Göteborg (SE)

(21) Appl. No.: 18/745,508

(22) Filed: Jun. 17, 2024

(30) Foreign Application Priority Data
Jun. 17, 2023 (EP) 23185836.6

(51) Int. Cl. B60W 30/14; H04W 4/46

(52) U.S. Cl. CPC B60W 30/143; H04W 4/46; B60W 2520/10; B60W 2552/15; B60W 2554/80; B60W 2555/60; B60W 2556/50; B60W 2556/65

(57) ABSTRACT

A computer system comprising processing circuitry is provided. The processing circuitry is configured to evaluate, based on topography data of an upcoming road segment, use of upcoming topography to achieve a target speed range of a vehicle operating in a topography fuel efficiency mode. The processing circuitry is further configured to determine all trailing vehicles within a predetermined range are operating in a fuel efficiency mode corresponding to the topography fuel efficiency mode and responsive to determining that all trailing vehicles within the predetermined range are operating in a propulsion mode corresponding to the topography fuel efficiency mode, permit a current speed of the vehicle to temporarily deviate below the target speed range of the vehicle and to use the upcoming topography to achieve the target speed.

### TECHNICAL FIELD

The disclosure relates generally to cruise control. In particular aspects, the disclosure relates to a cruise controller configured for energy efficiency and reduced impact on a flow of traffic. The disclosure can be applied to heavy-duty vehicles, such as trucks, buses, and construction equipment, among other vehicle types. Although the disclosure may be described with respect to a particular vehicle, the disclosure is not restricted to any particular vehicle.

### BACKGROUND

Eco-driving, also known as green driving or fuel-efficient driving, is a concept that promotes driving techniques and habits aimed at reducing fuel consumption and environmental impact of vehicles while maintaining safe and comfortable driving conditions. Rapid acceleration and harsh braking lead to increased fuel consumption. Eco-driving encourages gradual acceleration and deceleration, allowing the vehicle to reach a steady speed more efficiently.

Different operators and vehicles implement eco-driving differently. Some operators limit a maximum speed of a vehicle while other operators may prefer a higher maximum speed, but accelerate more slowly to reach the maximum speed. The different implementations of eco-driving may negatively impact the flow of traffic increasing a need of acceleration and braking thereby increasing fuel consumption and causing irritation and/or frustration of fellow road users.

### SUMMARY

According to a first aspect of the disclosure, a computer system comprising processing circuitry is presented. The processing circuitry is configured to evaluate, based on topography data of an upcoming road segment, use of upcoming topography to achieve a target speed range of a vehicle operating in a topography fuel efficiency mode. The processing circuitry is further configured to determine all trailing vehicles within a predetermined range are operating in a propulsion mode corresponding to the topography fuel efficiency mode and responsive to determining that all trailing vehicles within the predetermined range are operating in the propulsion mode corresponding to the topography fuel efficiency mode, permit a current speed of the vehicle to temporarily deviate below the target speed range of the vehicle and to use the upcoming topography to achieve the target speed range. The first aspect of the disclosure may seek to allow fuel efficient propelling of a vehicle without hampering a flow of traffic. A technical benefit may include that fuel efficient driving is enabled without fellow road users being adversely affected.

Optionally in some examples, including in at least one preferred example, the target speed range of the vehicle comprises a speed limit of a current road segment. A technical benefit may include that the speed of the vehicle may be adapted to the speed limit, and acceleration to an increased speed limit may be provided in a fuel efficient manner by utilizing upcoming topology.

Optionally in some examples, including in at least one preferred example, the processing circuitry is further configured to permit the current speed of the vehicle to deviate below the target speed range of the vehicle by a configurable speed deviation. A technical benefit may include allowing the speed of the vehicle to be reduced sufficiently to ensure tradeoffs between fuel efficient propelling of the vehicle and disturbances to a flow of traffic.

Optionally in some examples, including in at least one preferred example, the processing circuitry is further configured to, responsive to the topography data indicating a change in slope of the upcoming road segment, configure the configurable speed deviation based on a travel time estimate for the vehicle to reach the road segment associated with the change in slope indicated by the topography data. A technical benefit may include allowing the speed of the vehicle to be reduced sufficiently to ensure tradeoffs between fuel efficient propelling of the vehicle and disturbances to a flow of traffic.

Optionally in some examples, including in at least one preferred example, the processing circuitry is further configured to configure the configurable speed deviation based on a geographical location of the vehicle. A technical benefit may include adapting the configurable speed deviation to local driving customs and patterns.

Optionally in some examples, including in at least one preferred example, the processing circuitry is further configured to configure the configurable speed deviation based on additional vehicle data, additional trailing vehicle data and/or environment data. A technical benefit may include saving further energy and further reducing an impact of fellow road users.

Optionally in some examples, including in at least one preferred example, the predetermined range is a time gap or a distance. A technical benefit may include allowing trailing vehicles to be accurately identified.

Optionally in some examples, including in at least one preferred example, the processing circuitry is configured to, for each of the trailing vehicles, request the propulsion mode of the trailing vehicle, and responsive to the associated request timing out, determine that the trailing vehicle is not operating in a mode corresponding to the topography fuel efficiency mode. A technical benefit may include accurately determining a propulsion mode of the trailing vehicles.

Optionally in some examples, including in at least one preferred example, the request the propulsion mode is provided across a vehicle-to-vehicle communications interface. A technical benefit may include providing communication across a readily available and cost-effective interface.

Optionally in some examples, including in at least one preferred example, the processing circuitry is configured to, obtain speed limit data of the current road segment, and configure the configurable speed deviation based on the speed limit data. A technical benefit may include saving further energy and further reducing an impact of fellow road users.

Optionally in some examples, including in at least one preferred example, the target speed range of the vehicle is a range comprising a speed limit of a current road segment; the processing circuitry is further configured to: permit the current speed of the vehicle to deviate below the target speed range of the vehicle by a configurable speed deviation; the processing circuitry is further configured to: responsive to the topography data indicating a change in slope of the upcoming road segment, configure the configurable speed deviation based on an estimate a travel time for the vehicle to reach the road segment associated with the change in slope indicated by the topography data; the processing circuitry is further configured to: configure the configurable speed deviation based on a geographical location of the vehicle; the processing circuitry is further configured to: configure the configurable speed deviation based on additional vehicle data, additional trailing vehicle data and/or environment data; the predetermined range is a time gap or a distance; the processing circuitry is configured to, for each of the trailing vehicles: request the propulsion mode of the trailing vehicle, and responsive to the associated request timing out, determine that the trailing vehicle is not operating in a mode corresponding to the topography fuel efficiency mode; the request for the propulsion mode is provided across a vehicle-to-vehicle communications interface; the vehicle-to-vehicle communications interface is a direct interface between at least the vehicle and one of the one or more trailing vehicles or the vehicle-to-vehicle communications interface is a cloud interface; and the processing circuitry is further configured to: obtain speed limit data of the current road segment; and configure the configurable speed deviation based on the speed limit data. A technical benefit may include allowing trailing vehicles to be accurately identified and their propulsion mode accurately determined. A technical benefit may include allowing the speed of the vehicle to be reduced sufficiently to ensure tradeoffs between fuel efficient propelling of the vehicle and disturbances to a flow of traffic. A technical benefit may include that the speed of the vehicle may be adapted to the speed limit, and acceleration to an increased speed limit may be provided in a fuel efficient manner by utilizing upcoming topology.

According to a second aspect of the disclosure, a vehicle comprising the computer system of the first aspect is presented. The second aspect of the disclosure may seek to allow fuel efficient propelling of a vehicle without hampering a flow of traffic. A technical benefit may include that fuel efficient driving is enabled without fellow road users being adversely affected.

According to a third aspect of the disclosure, a computer-implemented method is presented. The computer implemented method comprises evaluating, by a processing circuitry of a computer system, based on topography data of an upcoming road segment, use of upcoming topography to achieve a target speed range of a vehicle operating in a topography fuel efficiency mode. The computer implemented method further comprises, determining all trailing vehicles within a predetermined range are operating in a propulsion mode corresponding to the topography fuel efficiency mode and responsive to determining that all trailing vehicles within the predetermined range are operating in a propulsion mode corresponding to the topography fuel efficiency mode, permitting, by the processing circuitry of the computer system, a current speed of the vehicle to temporarily deviate below the target speed range of the vehicle and to use the upcoming topography to achieve the target speed range. The third aspect of the disclosure may seek to allow fuel efficient propelling of a vehicle without hampering a flow of traffic. A technical benefit may include that fuel efficient driving is enabled without fellow road users being adversely affected.

According to a fourth aspect of the disclosure, a computer program product comprising program code for performing, when executed by the processing circuitry, the method of the second aspect. The fourth aspect of the disclosure may seek to allow fuel efficient propelling of a vehicle without hampering a flow of traffic. A technical benefit may include that fuel efficient driving is enabled without fellow road users being adversely affected.

According to a fifth aspect of the disclosure, a non-transitory computer-readable storage medium comprising instructions, which when executed by the processing circuitry, cause the processing circuitry to perform the method of the second aspect. The fifth aspect of the disclosure may seek to allow fuel efficient propelling of a vehicle without hampering a flow of traffic. A technical benefit may include that fuel efficient driving is enabled without fellow road users being adversely affected.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

There are also disclosed herein computer devices, control units, code modules, computer-implemented methods, computer readable media, and computer program products associated with the above discussed technical benefits.

### BRIEF DESCRIPTION OF THE DRAWINGS

Examples are described in more detail below with reference to the appended drawings.

FIG. 1A is an exemplary side view of a vehicle according to an example.

FIG. 1B is an exemplary block diagram of a vehicle according to an example.

FIG. 2 is an exemplary flow chart of a computer system according to an example.

FIG. 3A is an exemplary software architecture according to an example.

FIG. 3B is an exemplary flowchart according to an example.

FIG. 4 is an exemplary graph view of a speed manager according to an example.

FIG. 5 is an exemplary graph view of a speed manager according to an example.

FIG. 6 is an exemplary graph view of a speed manager according to an example.

FIG. 7 is an exemplary block diagram of a method according to an example.

FIG. 8 is an exemplary view of a computer program product according to an example.

FIG. 9 is a schematic diagram of an exemplary computer device for implementing examples disclosed herein, according to an example.

### DETAILED DESCRIPTION

The detailed description set forth below provides information and examples of the disclosed technology with sufficient detail to enable those skilled in the art to practice the disclosure.

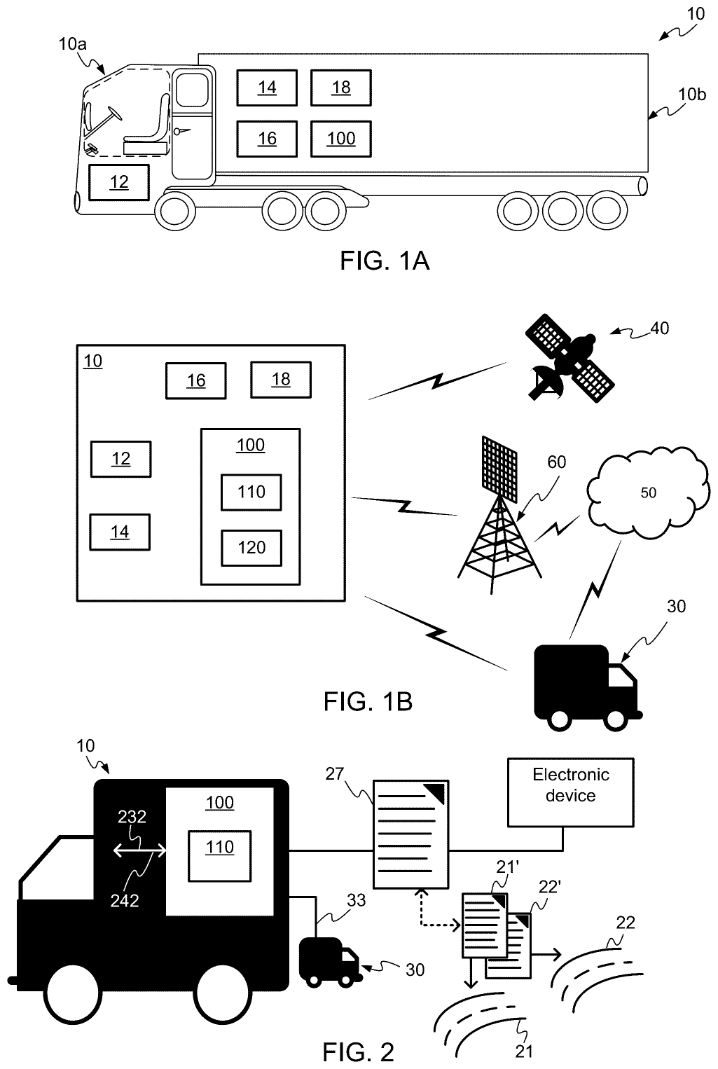

FIG. 1A is an exemplary schematic side view of a heavy-duty vehicle 10 (hereinafter referred to as vehicle 10). The vehicle 10 comprises a tractor unit 10a which is arranged to tow a trailer unit 10b. In other examples, other vehicles may be employed, e.g., trucks, buses, and construction equipment. The vehicle 10 comprises all vehicle units and associated functionality to operate as expected, such as a powertrain, chassis, and various control systems. The vehicle 10 comprises one or more propulsion sources 12. The propulsion source 12 may be any suitable propulsion source 12 exemplified by, but not limited to, one or more or a combination of an electrical motor, a combustion engine such as a diesel, gas or gasoline powered engine. The vehicle 10 further comprises an energy source 14 suitable for providing energy for the propulsion source 12. That is to say, if the propulsion source 12 is an electrical motor, a suitable energy source 14 would be a battery or a fuel cell. The vehicle 10 further comprises sensor circuitry 16 arranged to detect, measure, sense or otherwise obtain data relevant for operation of the vehicle 10. The sensor circuit 16 may comprise one or more of an accelerometer, a gyroscope, a wheel Speed Sensor, an ABS sensor, a throttle position sensor, a fuel level sensor, a temperature Sensor, a pressure sensor, a rain sensor, a light sensor, proximity sensor, a lane departure warning sensor, a blind spot detection sensor, a TPMS sensor etc. The data relevant for operation of the vehicle 10 may include, but is not limited to, one or more of a speed of the vehicle 10, a weight of the vehicle 10, an inclination of the vehicle 10, a status of the energy source 14 of the vehicle 10 (state of charge, fuel level etc.), a presence of road users in a vicinity of the vehicle 10, a current speed limit of a current road travelled by the vehicle 10, etc. The vehicle 10 further comprises communications circuitry 18 configured to receive and/or send communication. The vehicle further comprises a computer system 100, the computer system 100 will be further explained in following sections.

FIG. 1B is a block view of the vehicle 10. In FIG. 1B. The vehicle 10 may be in operative communication with external devices, such as one or more trailing vehicles 30. The connection may be provided by e.g. the communications circuitry 18. The term trailing vehicles 30 is to mean a vehicle traveling behind (along a same road) the vehicle 10 within a predetermined range. The vehicle 10 may be in communication with the trailing vehicle 30 directly or via a cloud (backend) server 50. The vehicle 10 may communicate with the cloud server 50 directly or via a communications interface such as a cellular communications interface 60, such as a radio base station. The cloud server 50 may be any suitable cloud server exemplified by, but not limited to, Amazon Web Services (AWS), Microsoft Azure, Google Cloud Platform (GCP), IBM Cloud, Oracle Cloud Infrastructure (OCI), DigitalOcean, Vultr, Linode, Alibaba Cloud, Rackspace etc. The communications interface may be a wireless communications interface exemplified by, but not limited to, Wi-Fi, Bluetooth, Zigbee, Z-Wave, LoRa, Sigfox, 2G (GSM, CDMA), 3G (UMTS, CDMA2000), 4G (LTE), 5G (NR) etc. Communication with the trailing vehicles 30 may be provided by any suitable vehicle-to-vehicle (V2V) communications protocol exemplified by, but not limited to Dedicated Short-Range Communications (DSRC), Cellular Vehicle-to-Everything (C-V2X), IEEE 802.11p, LTE-V (LTE-V2X), 5G NR (New Radio) V2X, etc. The vehicle 10 may further be operatively connected to a Global Navigation Satellite System (GNSS) 40 exemplified by, but not limited to, global positioning system (GPS), Globalnaya Navigatsionnaya Sputnikovaya Sistema (GLONASS), Galileo, BeiDou Navigation Satellite System, Navigation with Indian Constellation (NavIC) etc. The vehicle 10 may be configured to utilize data obtain from the GNSS 40 to determine a geographical location of the vehicle 10.

The computer system 100 of the vehicle 10 is may be operatively connected to the communications circuitry 18, the sensor circuitry 16, the energy source 14 and/or the propulsion source 12 of the vehicle 10. The computer system 100 comprises processing circuitry 110. The computer system 100 may comprise a storage device 120, advantageously a non-volatile storage device such as a hard disk drives (HDDs), solid-state drives (SSDs) etc. In some examples, the storage device 120 is operatively connected to the computer system 100.

By keeping track of a driving configuration of trailing vehicles 30, eco-driving may be utilized more freely without hampering a flow of traffic or risking causing accidents. To exemplify, if a vehicle is propelled in an eco-friendly mode, the topology of the road may be taken into account when planning acceleration and deceleration (braking). It may be preferred to postpone an acceleration event in anticipation of a downhill segment of the road as gravity will assist in accelerating the vehicle 10. Consequently, increasing a speed of a vehicle 10 by a specific amount will consume less of the energy source 14 of the vehicle 10 if the acceleration is performed at a downhill sloping road segment compared to if the acceleration was performed at a flat or uphill segment of the road. However, assume an uphill road segment and that a speed limit of the road increases a distance before a crest of the uphill road segment. The eco-friendly way of propelling the vehicle 10 would be to wait with acceleration of the vehicle 10 to the higher speed limit until the crest is reached. This type of operation of the vehicle 10 will be referenced to as topology based operation. However, this would force any vehicle 10 following the present vehicle 10 to either also wait with acceleration, or overtake the present vehicle 10. In order to avoid such issues, the vehicle 10 is selectively operated in the topology based eco-friendly way based, not only on a presence of any trailing vehicles 30, but on a current mode of operation of the trailing vehicles 30. If a trailing vehicle 30 also operates in a topology based mode of operation, the vehicle 10 may wait to accelerate until the topology of the road presents a more energy efficient slope (or lack of slope) for accelerating.

Topology based operation may be performed by a cruise control circuitry of a vehicle 10 or by an operator of a vehicle (remote or local). Regardless of where, by whom, or by what topology based operation of a vehicle 10 is performed, the vehicle 10 is operating in a topography fuel efficiency mode, discussed in more detail below. The topography fuel efficiency mode generally permits the vehicle 10 to deviate from a target speed, or target speed range, of the vehicle 10. The deviation may be either positive, negative or both positive and negative such that a range encompassing the target speed or target speed range is formed. The topography fuel efficiency mode permits the current speed of the vehicle 10 to at least deviate below the target speed. The target speed range may be a range defined by an upper speed limit and lower speed limit. Generally, a cruise controller is implemented to operate a target speed range to avoid unnecessary braking and acceleration of the vehicle 10 duc to e.g. minor shift in a slope of the road, gusts of wind etc. The upper speed limit of the target speed range may be defined as a fixed deviation from the target speed or a deviation by a fraction of the target speed. The lower speed limit of the target speed range may be defined as a fixed deviation from the target speed or deviation by a fraction of the target speed. The deviation from the target speed range may scale with the target speed, such that lower target speeds have a tighter target speed range compared to higher target speeds.

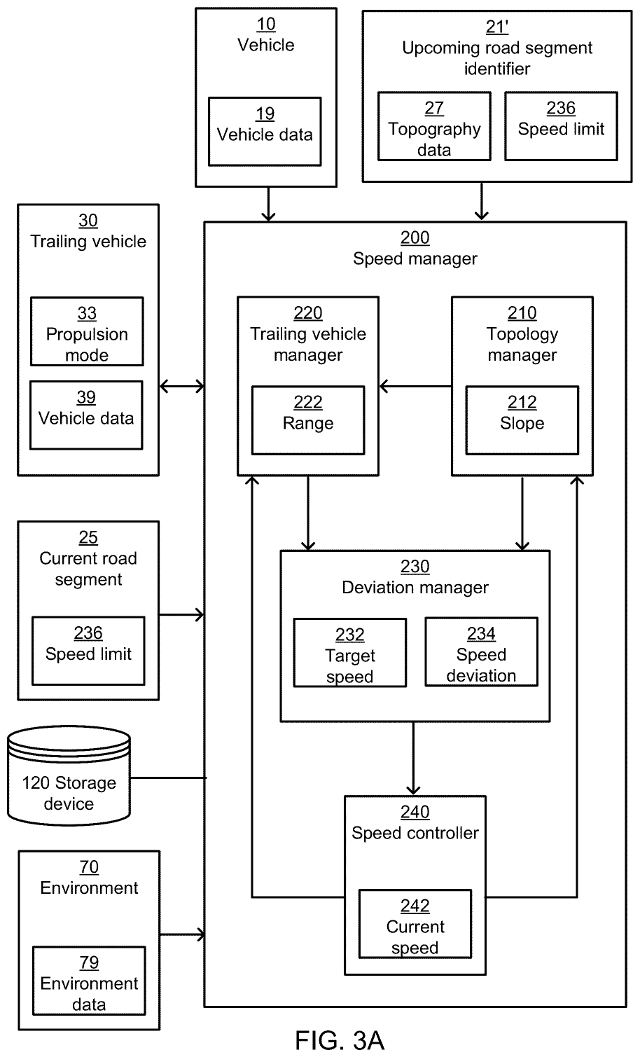

With reference to FIG. 2, the computer system 100 and associated functionality and features will be discussed in some further detail. The computer system 100 may be configured to obtain topography data 27 associated with an identifier 21′, 22′ of an upcoming road segment 21, 22. The topography data 27 may be obtained, as shown in FIG. 2, from an electronic device. The electronic device may be the cloud server 50 or a local storage of the vehicle 10, such as the previously presented storage device 120 of the computer system 100. The topography data 27 may be any suitable information concerning physical features and characteristics of the Earth's surface. The topography data 27 may comprise details such as, but not limited to, elevation, slope, terrain, landforms, and/or other spatial attributes. The topography data 27 may be exemplified by, but not limited to, Digital Elevation Models (DEMs), contour lines, slope and aspect maps etc. The topography data 27 may be produced by e.g. government agencies, research institutions, and/or commercial providers.

The computer system 100 is may further be configured to evaluate the topography data 27 to see if there is an opportunity to operate the vehicle 10 in the topography fuel efficiency mode, i.e. to wait with acceleration of the vehicle 10 until the upcoming road segment 21, 22 is reached. However, the computer system 100 may only permit operation in the topography fuel efficiency mode if doing so will not adversely affect the flow of following traffic. To this, end, if there are no trailing vehicles 30, the vehicle 10 may freely operate at the topography fuel efficiency mode and permit a speed 242 of the vehicle 10 to temporarily deviate below a target speed range 232 of the vehicle 10 and to use the upcoming topography to achieve the target speed range 232. Target speed range 232 is generally a target speed with tolerable deviation. This deviation may be a percentage deviation based of the target speed. Generally, an upper limit of the target speed range 232 is closer to the target speed than a lower limit of the target speed range 232, i.e. there is more headroom for deviation below the target speed than above the target speed. However, if there are trailing vehicles 30 and all these are also operating in the topography fuel efficiency mode, or a propulsion mode 33 corresponding to the topography fuel efficiency mode, the trailing vehicles 30 may be ignored and the computer system 10 may be configured to permit the speed 242 of the vehicle 10 to temporarily deviate below the target speed range 232 of the vehicle 10 and to use the upcoming topography to achieve the target speed 232. If one or more of the trailing vehicles 30 are not operating the topography fuel efficiency mode, or a propulsion mode 33 corresponding to the topography fuel efficiency mode, or if the vehicle has not received a response from each target trailing vehicle, the computer system 100 may be configured to prevent the speed 242 of the vehicle 10 to deviate below the target speed range 232 of the vehicle 10.

To this end, the computer system 100 may be configured to obtain a propulsion mode 33 of the trailing vehicles 30 to determine if the trailing vehicles 30 are operating in the topography fuel efficiency mode, or a propulsion mode 33 corresponding to the topography fuel efficiency mode. The propulsion mode 33 may be obtained from the trailing vehicles 30 across a suitable V2V interface as previously mentioned. Alternatively, or additionally, the propulsion mode 33 of the trailing vehicles 30 may be obtained from, or provided by the cloud server 50 across any suitably communications interface such as the previously exemplified wireless interfaces.

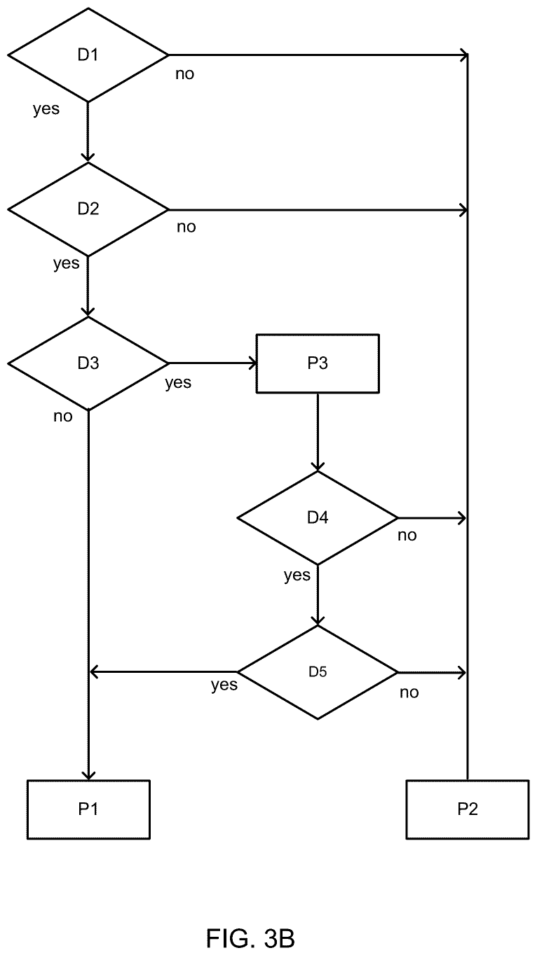

With reference to FIG. 3A, an architectural example of how a speed manager 200 may be implemented. The functions and features described with reference to the speed manager 200 are implemented and provided by the computer system 100 presented herein. The speed manager 200 may comprise a topology manager 210, a trailing vehicle manager 220, a deviation manager 230, and a speed controller 240.

The topology manager 210 determines whether using upcoming topography to achieve a target speed range 232 is fuel efficient. This may be achieved in numerous different ways and the following is provided as examples and should not be considered exhaustive. In some examples, the topology manager 210 may be configured to obtain topography data 27 of an upcoming road segment 21 identified by an upcoming road segment identifier 21′. The topography data 27 may be any suitable topography data 27, such as the topography data exemplified herein. The topography data 27 may be obtained from a storage device 120 operatively connected to the speed manager 200 or from the cloud server 50. The topography manager 210 may be configured to determine a geographical location of the vehicle 10 by e.g. data obtained from the GNSS 40 as exemplified herein. The topography manager 210 may be configured to determine a slope 212 of the upcoming road segment 21 based on the topography data 27. The topography manager 210 may be configured to determine that using the upcoming topography is fuel efficient to achieve a target speed range 232 responsive to the topography data 27 of the upcoming road segment 21 indicating that a downhill segment is approaching. A downhill segment may be indicated by a negative slope 212. In some examples, the topography manager 210 may be configured to determine that using the upcoming topography is fuel efficient to achieve a target speed range 232 responsive to the topography data 27 of the upcoming road segment 21 indicating a segment with a less steep uphill slope 212 compared to a current road segment. The topography manager 210 may further be configured to determine a distance and/or travel time to the downhill (or flat, or less steep uphill) segment. To this end, the topography manager 210 may be configured to obtain a current speed 242 of the vehicle 10, such as from the speed controller 240. The topography manager 210 may further be configured to determine a distance and/or travel time to a change in slope 212.

In some examples, the topography manager 210 may be configured to determine that maintain a target speed range 232 at the upcoming topography is fuel inefficient. This may be the case when a steep uphill segment is followed by flat or downhill segments. An uphill segment may be indicated by a positive slope 212. The topography manager 210 may further be configured to determine a distance and/or travel time to the uphill segment.

The trailing vehicle manager 220 determines whether all trailing vehicles 30 are operating in a propulsion mode 33 corresponding to the topography fuel efficiency mode. This may be achieved in numerous different ways and the following is provided as examples and should not be considered exhaustive. In some examples, the trailing vehicle manager 220 is configured to determine a presence of any trailing vehicles 30 within a predetermined range 222. The predetermined range 222 may be a preconfigured range, a range determined based on a current speed 242 of the vehicle 10, a range determined based on a following vehicle distance, following vehicle speed, host vehicle speed, host vehicle distance to the change in slope, and/or travel time to the change in slope 212, or a combination of these. The trailing vehicle manager 220 may be configured to determine presence of trailing vehicles 30 within the predetermined range 222 by any suitable technology. In some examples, the trailing vehicle manager 220 may be configured to determine presence of trailing vehicles 30 within the predetermined range 222 by utilization of data from e.g. the sensor circuitry 16, such as e.g. camera circuitry, radar circuitry etc. Additionally, or alternatively, the trailing vehicle manager 220 may be configured to determine presence of trailing vehicles 30 within the predetermined range 222 by utilization of data from e.g. the cloud server 50 by providing a current geographical location of the vehicle 10 to the cloud server 50, optionally together with the predetermined range 222, and obtaining data indicating at least presence or absence or trailing vehicles 30. The predetermined range 222 may be extended if a distance between trailing vehicles 30 is below a predetermined threshold (which may be determined based on the same basis as the predetermined range 222). This is advantageous in situations where a line of trailing vehicles 30 extend beyond the initially predetermined range 222.

If the trailing vehicle manager 220 determines a presence of trailing vehicles 30, the trailing vehicle manager 220 may obtain a propulsion mode 33 of each of the trailing vehicles 30. The propulsion mode 33 of the trailing vehicles 30 may be obtained in numerous different ways and the following is provided as examples and should not be considered exhaustive. In some examples, the trailing vehicle manager 220 may be configured to request each of the trailing vehicles 30 to provide a propulsion mode 33. The request may be provided across any suitable interface such as the exemplified V2V interfaces. In some examples, the request is provided to a first trailing vehicle 30 closest behind the vehicle 10, and the first trailing vehicle relays the request to a second trailing vehicle immediately behind the first trailing vehicle and so on until no further trailing vehicles remain within the (extended) predetermined range 222. The response from the trailing vehicles 30 may be sent across the same interface as the request, but in an opposite direction. Alternatively, the response may be sent across a different interface from the request, or obtained from e.g. the cloud server 50. If data is obtained indicative of all trailing vehicles 30 operating in a propulsion mode 33 corresponding to the topography fuel efficiency mode, the trailing vehicle manager 220 may determine that all trailing vehicles 30 are operating in the topography fuel efficiency mode. The trailing vehicle manager 220 may be configured to determine that not all vehicles are operating in the topography fuel efficiency mode responsive to at least one trailing vehicle 30 within the predetermined range 222 indicating a propulsion mode 33 that does not correspond to the topography fuel efficiency mode. Additionally, or alternatively, the trailing vehicle manager 220 may be configured to determine that not all trailing vehicles 30 within the predetermined range 222 are operating in the topography fuel efficiency mode responsive to at least one trailing vehicle 30 within the predetermined range 222 failing to provide a response to the request for propulsion mode 33. In other words, if the request times out, it is assumed that the associated trailing vehicle 30 is not operating in the topography fuel efficiency mode.

The deviation manager 230 may be configured to determine if the current speed 242 of the vehicle 10 is permitted to temporarily deviate below the target speed range 232 of the vehicle 10. This may be achieved in numerous different ways and the following is provided as examples and should not be considered exhaustive. In some examples, the deviation manager 230 may be configured to permit the current speed 242 of the vehicle 10 to temporarily deviate below the target speed range 232 of the vehicle 10 responsive to the trailing vehicle manager 220 determining that all trailing vehicles 30 within the predetermined range 222 are operating in the topography fuel efficiency mode. The target speed range 232 may comprise a speed limit 236 of a current road segment 25, i.e. a current speed limit 236. In some examples, the deviation manager 230 may be configured to permit the current speed 242 of the vehicle 10 to temporarily deviate below the target speed range 232 of the vehicle 10 by a configurable speed deviation 234. The configurable speed deviation 234 may be configured based on an estimated travel time for the vehicle 10 to reach an upcoming change in slope 212. Additionally, or alternatively, the configurable speed deviation 234 may be configured based on a slope of the current road segment 25. In some examples, the configurable speed deviation 234 may be configured based on a geographical location of the vehicle 10. That is to say, in some countries, regions or locations, operators and fellow road users may be more inclined to accept larger deviations in vehicle speed than in other regions. Additionally, or alternatively, the configurable speed deviation 234 may be configured based on vehicle data 19. Vehicle data 19 may be any suitable parameters indicating operational data of the vehicle 10. The vehicle data 19 may be exemplified by, but is not limited to, a weight of the vehicle, a current driving mode of the vehicle 10 (e.g. level of cco-driving etc.), a status of the energy source 14 etc. Additionally, or alternatively, the configurable speed deviation 234 may be configured based on trailing vehicle data 39. The trailing vehicle data 39 may be exemplified by, but is not limited to, a weight of the trailing vehicle 30, a current driving mode of the trailing vehicle 30 (e.g. level of eco-driving etc.), a status of an energy source of the trailing vehicle 30 etc. The trailing vehicle data 39 may be obtained correspondingly to the propulsion mode 33 of the trailing vehicle 30. Additionally, or alternatively, the configurable speed deviation 234 may be configured based on environment data 79. The environment data 79 may be any data associated with an environment 70 of the vehicle 10. The environment data 79 may be exemplified by, but is not limited to, traffic conditions, weather data etc. For instance, a strong head wind may lead to an increased configurable speed deviation 234, a risk of icy roads may lead to a decreased configurable speed deviation 234 etc.

The deviation manager 230 may be configured to reset the configurable speed deviation 234 to zero, or disable the configurable speed deviation 234 responsive to the slope 212 no longer indicating that there is an opportunity or need to accelerate the vehicle 10 by assistance of a slope 212 of an upcoming road segment 21.

The speed controller 240 may be configured to control the current speed 242 of the vehicle 10, such as within the target speed range 232. If the current speed 242 of the vehicle 10 is permitted to temporarily deviate below the target speed range 232, the speed controller 240 may control the current speed of the vehicle 10 to deviate below the target speed range 232. In some examples, if the current speed 242 of the vehicle 10 is permitted to temporarily deviate below the target speed range 232, the speed controller 240 may control the current speed 242 of the vehicle 10 to deviate below the target speed range 232 by the configurable speed deviation 234. It should be mentioned that the speed controller may control mainly positive acceleration in scenarios when the current speed 242 of the vehicle 10 is permitted to temporarily deviate below the target speed range 232. In other words, in the topology based fuel efficiency mode (the topography fuel efficiency mode) of operation, the speed controller 240 will generally not (regeneratively) brake the vehicle 10 to reach the lowest speed permitted or reduce the speed of the vehicle 10.

In FIG. 3B, an exemplary flow-chart describing some logical steps of the when to permit operation in the topography fuel efficiency mode, and when to prevent operation in the topography fuel efficiency mode. A first decision point D1 determines if a request for operating in the topography based fuel efficiency mode is received. If the first decision point D1 determines that no request for operating in the topography based fuel efficiency mode is received, the second process P2 is entered (the path marked with “no” in from the first decision point D1 in FIG. 3B). The second process P2 prevents operation of the vehicle 10 in the topography fuel efficiency mode. If the first decision point D1 determines that a request for operating in the topography based fuel efficiency mode is received, a second decision point D2 is reached (the path marked with “yes” from the first decision point D1 in FIG. 3B). The second decision point D2 determines if operation in the topography based fuel efficiency mode is beneficial. The determination of whether operation in the topography based fuel efficiency mode is beneficial or not may be based on e.g. topology of upcoming road segments 21, 22, a change in speed limit 236 or any other feature, function or example presenter herein. If the second decision point D2 determines that operation in the topography based fuel efficiency mode is not beneficial, the second process P2 is entered (the path marked with “no” in from the first decision point D2 in FIG. 3B). If the second decision point D2 determines that it is beneficial to operate in the topography based fuel efficiency mode, a third decision point D3 is reached (the path marked with “yes” from the second decision point D2 in FIG. 3B). The third decision point D3 determines presence of any trailing vehicles 30 within the predetermined range 222. Presence of trailing vehicles 30 may be determined in accordance with any example, function or feature presented herein. If the third decision point D3 determines that no trailing vehicles 30 are present within the predetermined range 222, a first process P1 is entered (the path marked with “no” from the third decision point D3 in FIG. 3B). At the first process P1, the vehicle 10 is operated in the topography fuel efficiency mode as described herein. If the third decision point D3 determines that trailing vehicles 30 are present within the predetermined range 222, a third process P3 is entered (the path marked with “yes” from the third decision point D3 in FIG. 3B). At the third process P3, requests are sent for propulsion modes 33 of the trailing vehicles 30. This may be performed as exemplified by any feature, function or device presented herein. After sending the request, a fourth decision point D4 is reached. The fourth decision point D4 determines if responses to the request are received from all trailing vehicles 30. If the fourth decision point determines that responses have not been received from all trailing vehicles 30 within the predetermined range 222, the second process P2 is entered (the path marked with “no” from the fourth decision point D4 in FIG. 3B). Determining that responses have not been received from all trailing vehicles 30 within the predetermined range 222 may be based on the request timing out. If the fourth decision point determines that responses have been received from all trailing vehicles 30 within the predetermined range 222, a fifth decision point D5 is reached (the path marked with “yes” from the fourth decision point D4 in FIG. 3B). The fifth decision point D5 determines if all responses indicate that the propulsion modes 33 of the trailing vehicles 30 within the predetermined range 222 are all corresponding to the topography fuel efficiency mode. If the fifth decision point D5 determines that at least one response indicates a propulsion modes 33 that does not correspond to the topography fuel efficiency mode, the second process P2 is entered (the path marked with “no” from the fifth decision point D5 in FIG. 3B). If the fifth decision point D5 determines that all responses indicate propulsion modes 33 corresponding to the topography fuel efficiency mode, the first process P1 in entered (the path marked with “yes” from the fifth decision point D5 in FIG. 3B).

The order of some of the decision points and processes presented in reference to FIG. 3B may be changed. To exemplify, the first decision point D1, the second decision point D2 and/or the third decision point D3 may be arranged anywhere upstream from the first process P1.

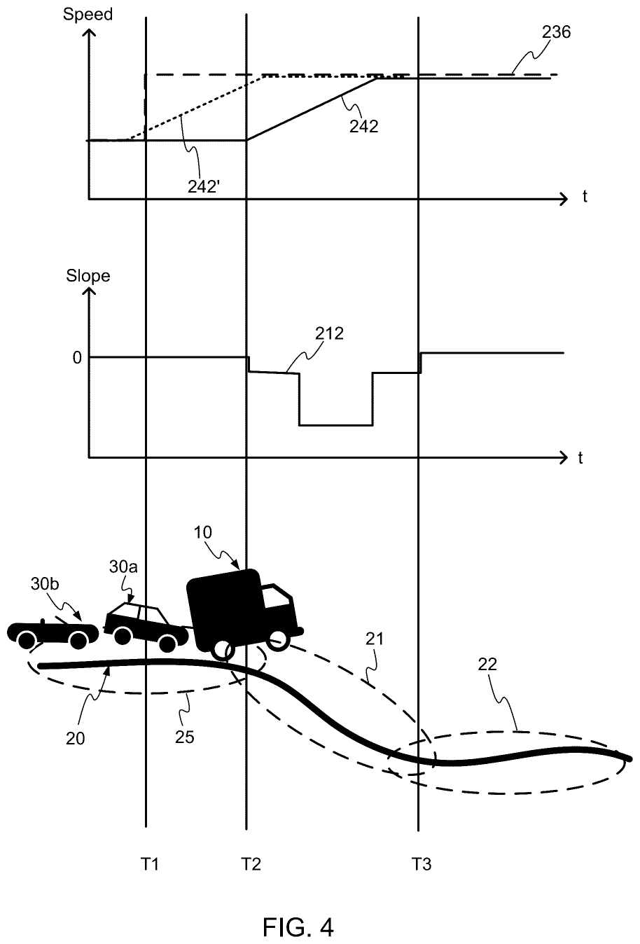

With reference to FIG. 4, a specific example of how the features of the present disclosure may be utilized will be explained. In FIG. 4 a vehicle 10 is traveling along a road 20. The top graph in FIG. 4 shows a speed 242 of the vehicle 10 versus time and the middle graph shows a slope 212 of the road 20. The bottom graph schematically shows the vehicle traveling along the road 20 and an inclination of the road 20. All three graphs are shown with aligned horizontal axes. As seen in the bottom graph, a first trailing vehicle 30a and a second trailing vehicle 30b are trailing the vehicle 10. The vehicle 10 is, at a first road segment 25 of the road 20.

At a first point in time T1 during the first road segment 25, a speed limit 236 (dashed line in top graph of FIG. 4) of the road 20 increases. At a second point in time T2, at a first upcoming road segment 21 following the current road segment 25, the slope 212 of the road 20 decreases. At a third point in time T3, at a second upcoming road segment 22 following the first upcoming road segment 21, the slope 212 of the road 20 increases. That is to say, at the second point in time T2 the vehicle 10 enters a downhill segment of the road 20 and at the third point in time T3, the vehicle 10 reaches a valley. In the top graph, the dotted line shows a conventional speed 242′ indicating how the speed of a conventional vehicle would change in the scenario of FIG. 4. The conventional vehicle would, in response to the increase in speed limit 236, start to accelerate, and accelerate until the conventional vehicle reaches the speed limit 236. At, or sufficiently ahead of the first point in time T1, the vehicle of the present disclosure will obtain (or try to obtain) propulsion modes 33 of the trailing vehicles 30a, 30b. This may be accomplished according to any example or feature described herein. To this end, the vehicle 10 of the present disclosure will, responsive to all trailing vehicles 30a, 30b within the predetermined range 222 operating in a propulsion mode 33 corresponding to the topography fuel efficiency mode, wait with acceleration until the second point in time T2 when the downhill road segment is reached. This causes the speed 242 of the vehicle to remain below the speed limit 236 of the road 20 for the duration of the current road segment 25 allowing the vehicle 10 to utilize the topology of the road 20 to accelerate to the speed limit 236 at the first upcoming road segment 21.

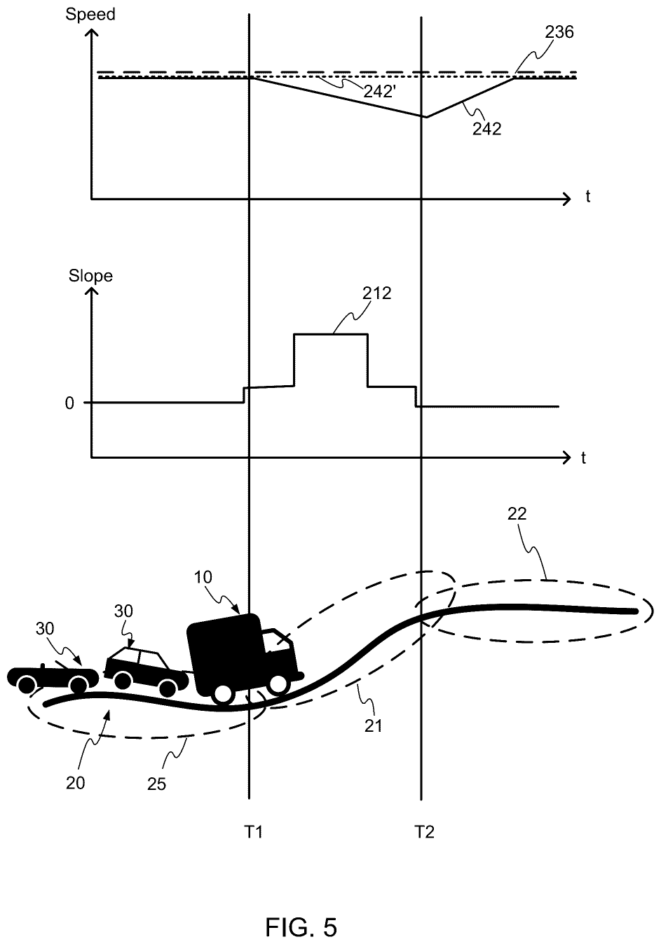

With reference to FIG. 5, another specific example of how the features of the present disclosure may be utilized will be explained. In FIG. 5, a vehicle 10 is traveling along a road 20. The top graph in FIG. 5 shows a speed 242 of the vehicle 10 versus time and the middle graph shows a slope 212 of the road 20. The bottom graph schematically shows the vehicle 10 traveling along the road 20 and an inclination of the road 20. All three graphs are shown with aligned horizontal axes. As seen in the bottom graph, a first trailing vehicle 30a and a second trailing vehicle 30b are trailing the vehicle 10. The vehicle 10 is, at a first road segment 25 of the road 20.

At a first point in time T1, at a first upcoming road segment 21 following the current road segment 25, the slope 212 of the road 20 increases. At a second point in time T2, at a second upcoming road segment 22 following the first upcoming road segment 21, the slope 212 of the road 20 decreases. That is to say, at the first point in time T1 the vehicle 10 enters an uphill segment of the road 20 and at the second point in time T2, the vehicle 10 reaches a crest. In the top graph, the dotted line shows a prior art speed 242′ indicating how the speed of a prior art vehicle would change in the scenario of FIG. 5. The prior art vehicle would maintain its speed through the uphill segment. At, or sufficiently ahead of the first point in time T1, the vehicle 10 of the present disclosure will obtain (or try to obtain) propulsion modes 33 of the trailing vehicles 30a, 30b. This may be accomplished according to any example or feature described herein. To this end, the vehicle 10 will, responsive to all trailing vehicles 30a, 30b within the predetermined range 222 operating in a propulsion mode 33 corresponding to the topography fuel efficiency mode, permit the current speed 242 of the vehicle 10 to temporarily deviate below the target speed range 232. This causes the speed 242 of the vehicle to deviate below the speed limit 236 of the road 20 for the duration of the uphill road segment 21 and then accelerating back to the speed limit 236 at the second point in time T2.

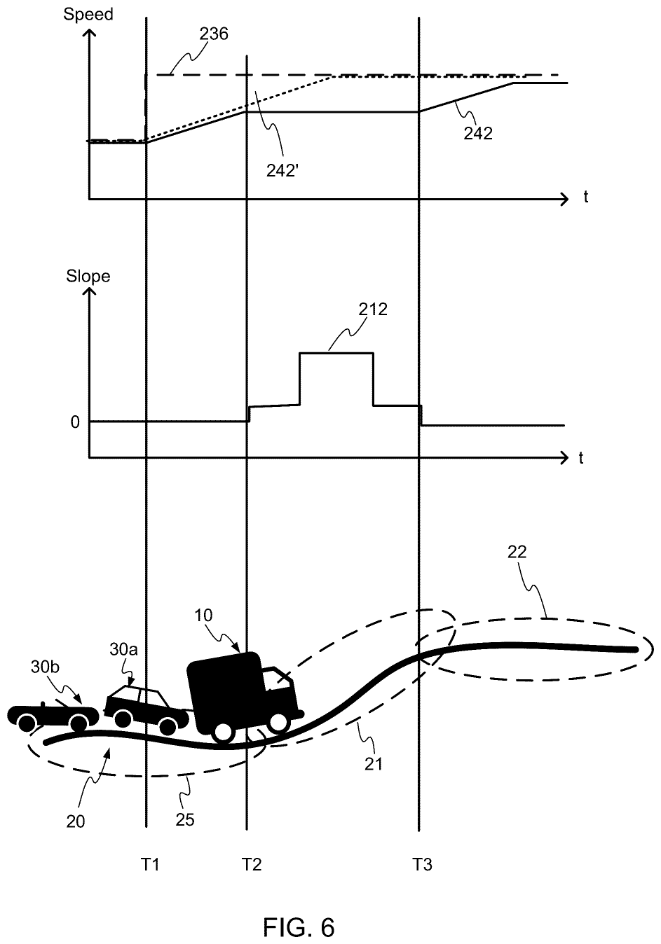

With reference to FIG. 6, yet another specific example of how the features of the present disclosure may be utilized will be explained. In FIG. 6 a vehicle 10 is traveling along a road 20. The top graph in FIG. 6 shows a speed 242 of the vehicle 10 versus time and the middle graph shows a slope 212 of the road 20. The bottom graph schematically shows the vehicle 10 traveling along the road 20 and an inclination of the road 20. All three graphs are shown with aligned horizontal axes. As seen in the bottom graph, a first trailing vehicle 30a and a second trailing vehicle 30b are trailing the vehicle 10. The vehicle 10 is, at a first road segment 25 of the road 20.

At a first point in time T1 during the first road segment 25, a speed limit 236 (dashed line in top graph of FIG. 6) of the road 20 increases. At a second point in time T2, at a first upcoming road segment 21 following the current road segment 25, the slope 212 of the road 20 increases. At a third point in time T3, at a second upcoming road segment 22 following the first upcoming road segment 21, the slope 212 of the road 20 decreases. That is to say, at the second point in time T2 the vehicle 10 enters an uphill segment of the road 20 and at the third point in time T3, the vehicle 10 reaches a crest. In the top graph, the dotted line shows a prior art speed 242′ indicating how the speed of a prior art vehicle would change in the scenario of FIG. 6. The prior art vehicle would, in response to the increase in speed limit 236, start to accelerate, and keep accelerating until the prior art vehicle reaches the speed limit 236. The prior art vehicle would accelerate through the uphill segment of the road 20. Correspondingly, also the vehicle 10 of the present disclosure may start to accelerate at the first point in time T1. At, or sufficiently ahead of the second point in time T2, the vehicle of the present disclosure will obtain (or try to obtain) propulsion modes 33 of the trailing vehicles 30a, 30b. This may be accomplished according to any example or feature described herein. To this end, the vehicle 10 of the present disclosure will, responsive to all trailing vehicles 30a, 30b within the predetermined range 222 operating in a propulsion mode 33 corresponding to the topography fuel efficiency mode, pause the acceleration until the third point in time T3 when the crest is reached. This causes the speed 242 of the vehicle to remain constantly below the speed limit 236 of the road 20 for the duration of the uphill segment allowing the vehicle 10 to accelerate to the speed limit 236 at the second upcoming road segment 22 where acceleration is more fuel efficient.

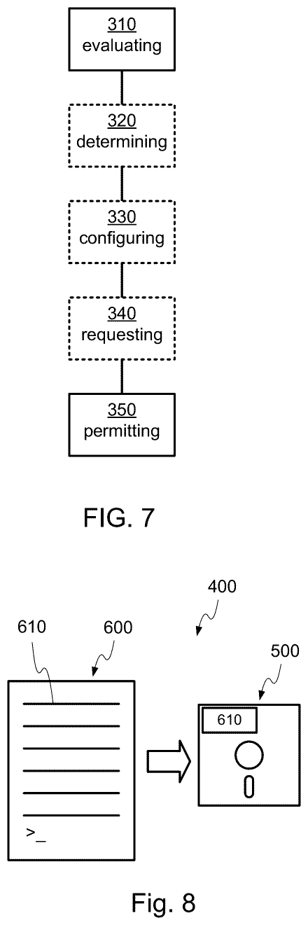

With reference to FIG. 7, a method 300 will be presented. The method 300 shown in FIG. 7 may be expanded and/or modified to comprise any suitable feature or function presented herein although not specifically mentioned in reference to FIG. 7. For instance, the method 300 may comprise all or some of the actions described with reference to FIG. 3A, FIG. 4, FIG. 5, and/or FIG. 6. The method 300 may be a computer implemented method and may be performed by the processing circuitry 110 of the computer system 100.

The method 300 comprises evaluating 310, based on topography data 27 of an upcoming road segment 21, 22, use of upcoming topography to achieve the target speed range 232 of a vehicle 10 operating in the topography fuel efficiency mode. The method 300 further comprises, determining 320 that all trailing vehicles within a predetermined range 222 are operating in a propulsion mode 33 corresponding to the topography fuel efficiency mode. Further, responsive to determining that all trailing vehicles 30 within the predetermined range 222 are operating in a propulsion mode 33 corresponding to the topography fuel efficiency mode, permitting 350 the current speed 242 of the vehicle 10 to temporarily deviate below the target speed range 232 of the vehicle 10 and to use the upcoming topography to achieve the target speed 232.

In some examples, the method 300 may further comprise configuring 330 the configurable speed deviation 234 according to any example or function presented herein.

In some examples, the method 300 may further comprises requesting 340 an indication of a propulsion mode 33 of the trailing vehicle 30 according to any example or function presented herein.

As with all other features, functions and examples presented herein, the method 300 may be performed in any suitable order.

In FIG. 8 a computer program product 400 is shown. The computer program product 400 comprises a computer program 600 and a non-transitory computer readable medium 500. The computer program 600 may be stored on the computer readable medium 500. The computer readable medium 500 is, in FIG. 8, exemplified as a vintage 5,25″ floppy disc, but may be embodied as any suitable non-transitory computer readable medium such as, but not limited to, hard disk drives (HDDs), solid-state drives (SSDs), optical discs (e.g., CD-ROM, DVD-ROM, CD-RW, DVD-RW), USB flash drives, magnetic tapes, memory cards, Read-Only Memories (ROM), network-attached storage (NAS), cloud storage etc.

The computer program 600 comprises instruction 610 e.g. program instruction, software code, that, when executed by processing circuitry cause the processing circuitry to perform the method 300 described herein with reference to FIG. 7.

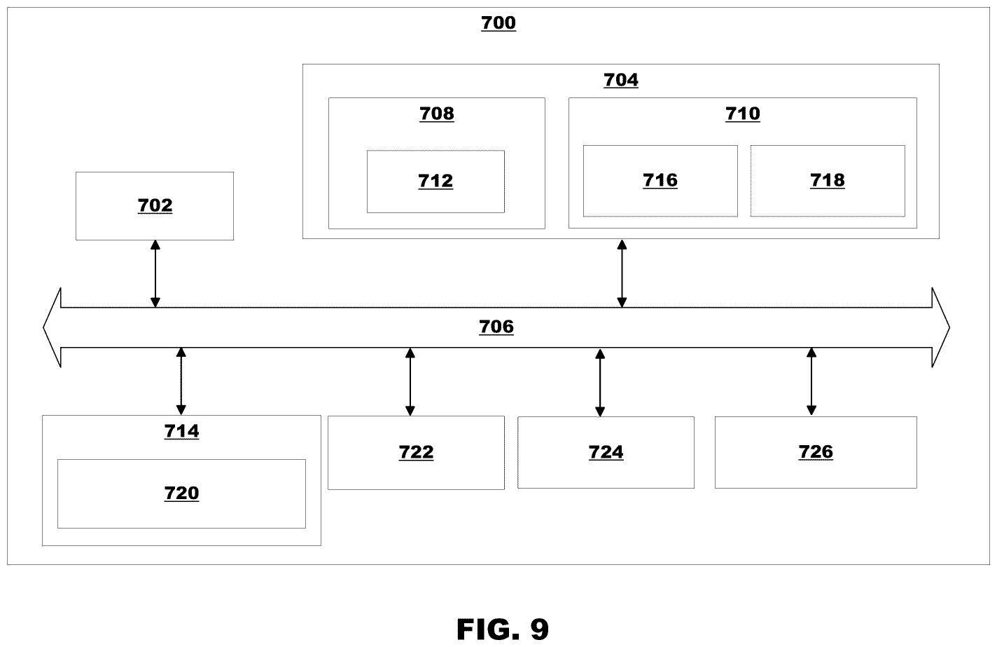

FIG. 9 is a schematic diagram of a computer system 700 for implementing examples disclosed herein. The computer system 700 of FIG. 9 may be the computer system 100 introduced with reference to FIG. 1A. The computer system 700 is adapted to execute instructions from a computer-readable medium to perform these and/or any of the functions or processing described herein. The computer system 700 may be connected (e.g., networked) to other machines in a LAN, an intranet, an extranet, or the Internet. While only a single device is illustrated, the computer system 700 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, processing circuitry, etc., includes reference to one or more such devices to individually or jointly execute a set (or multiple sets) of instructions to perform any one or more of the methodologies discussed herein. For example, control system may include a single control unit or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 700 may comprise at least one computing device or electronic device capable of including firmware, hardware, and/or executing software instructions to implement the functionality described herein. The computer system 700 may include processing circuitry 702 (e.g., processing circuitry including one or more processor devices or control units), a memory 704, and a system bus 706. The processing circuitry 702 in FIG. 9 may be the processing circuitry 110 introduced with reference to FIG. 1B. The memory 706 in FIG. 9 may be the storage device 120 introduced with reference to FIG. 1B. The computer system 700 may include at least one computing device having the processing circuitry 702. The system bus 706 provides an interface for system components including, but not limited to, the memory 704 and the processing circuitry 702. The processing circuitry 702 may include any number of hardware components for conducting data or signal processing or for executing computer code stored in memory 704. The processing circuitry 702 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processing circuitry 702 may further include computer executable code that controls operation of the programmable device.

The system bus 706 may be any of several types of bus structures that may further interconnect to a memory bus (with or without a memory controller), a peripheral bus, and/or a local bus using any of a variety of bus architectures. The memory 704 may be one or more devices for storing data and/or computer code for completing or facilitating methods described herein. The memory 704 may include database components, object code components, script components, or other types of information structure for supporting the various activities herein. Any distributed or local memory device may be utilized with the systems and methods of this description. The memory 704 may be communicably connected to the processing circuitry 702 (e.g., via a circuit or any other wired, wireless, or network connection) and may include computer code for executing one or more processes described herein. The memory 704 may include non-volatile memory 708 (e.g., read-only memory (ROM), erasable programmable read-only memory (EPROM), electrically erasable programmable read-only memory (EEPROM), etc.), and volatile memory 710 (e.g., random-access memory (RAM)), or any other medium which can be used to carry or store desired program code in the form of machine-executable instructions or data structures and which can be accessed by a computer or other machine with processing circuitry 702. A basic input/output system (BIOS) 712 may be stored in the non-volatile memory 708 and can include the basic routines that help to transfer information between elements within the computer system 700.

The computer system 700 may further include or be coupled to a non-transitory computer-readable storage medium such as the storage device 714, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 714 and other drives associated with computer-readable media and computer-usable media may provide non-volatile storage of data, data structures, computer-executable instructions, and the like.

Computer-code which is hard or soft coded may be provided in the form of one or more modules. The module(s) can be implemented as software and/or hard-coded in circuitry to implement the functionality described herein in whole or in part. The modules may be stored in the storage device 714 and/or in the volatile memory 710, which may include an operating system 716 and/or one or more program modules 718. All or a portion of the examples disclosed herein may be implemented as a computer program 720 stored on a transitory or non-transitory computer-usable or computer-readable storage medium (e.g., single medium or multiple media), such as the storage device 714, which includes complex programming instructions (e.g., complex computer-readable program code) to cause the processing circuitry 702 to carry out actions described herein. Thus, the computer-readable program code of the computer program 720 can comprise software instructions for implementing the functionality of the examples described herein when executed by the processing circuitry 702. In some examples, the storage device 714 may be a computer program product (e.g., readable storage medium) storing the computer program 720 thereon, where at least a portion of a computer program 720 may be loadable (e.g., into a processor) for implementing the functionality of the examples described herein when executed by the processing circuitry 702. The processing circuitry 702 may serve as a controller or control system for the computer system 700 that is to implement the functionality described herein. The computer system 700 may include an input device interface 722 configured to receive input and selections to be communicated to the computer system 700 when executing instructions, such as from a keyboard, mouse, touch-sensitive surface, etc. Such input devices may be connected to the processing circuitry 702 through the input device interface 722 coupled to the system bus 706 but can be connected through other interfaces, such as a parallel port, an Institute of Electrical and Electronic Engineers (IEEE) 1394 serial port, a Universal Serial Bus (USB) port, an IR interface, and the like. The computer system 700 may include an output device interface 724 configured to forward output, such as to a display, a video display unit (e.g., a liquid crystal display (LCD) or a cathode ray tube (CRT)). The computer system 700 may include a communications interface 726 suitable for communicating with a network as appropriate or desired.

The operational actions described in any of the exemplary aspects herein are described to provide examples and discussion. The actions may be performed by hardware components, may be embodied in machine-executable instructions to cause a processor to perform the actions, or may be performed by a combination of hardware and software. Although a specific order of method actions may be shown or described, the order of the actions may differ. In addition, two or more actions may be performed concurrently or with partial concurrence.

Example 1. A computer system 100 comprising processing circuitry 110 configured to: evaluate, based on topography data 27 of an upcoming road segment 21, 22, use of upcoming topography to achieve a target speed range 232 of a vehicle 10 operating in a topography fuel efficiency mode; determine all trailing vehicles within a predetermined range 222 are operating in a propulsion mode 33 corresponding to the topography fuel efficiency mode; responsive to determining that all trailing vehicles 30 within the predetermined range 222 are operating in a propulsion mode 33 corresponding to the topography fuel efficiency mode: permit a current speed 242 of the vehicle 10 to temporarily deviate below the target speed range 232 of the vehicle 10 and to use the upcoming topography to achieve the target speed 232.

Example 2. The computer system 100 of example 1, wherein the target speed range 232 of the vehicle 10 is a range comprising a speed limit 236 of a current road segment 25.

Example 3. The computer system of example 1 or 2, wherein the processing circuitry 110 is further configured to: permit the current speed 242 of the vehicle 10 to deviate below the target speed range 232 of the vehicle 10 by a configurable speed deviation 234.

Example 4. The computer system 100 of example 3, wherein the processing circuitry 110 is further configured to: responsive to the topography data 27 indicating a change in slope 212 of the upcoming road segment 21, 22, configure the configurable speed deviation 234 based on an estimate a travel time for the vehicle 10 to reach the road segment associated with the change in slope 212 indicated by the topography data 27.

Example 5. The computer system 100 of example 3 or 4, wherein the processing circuitry 110 is further configured to: configure the configurable speed deviation 234 based on a geographical location of the vehicle 10.

Example 6. The computer system 100 of any one of examples 3-5, wherein the processing circuitry 110 is further configured to: configure the configurable speed deviation 234 based on additional vehicle data 19, additional trailing vehicle data 39 and/or environment data 79.

Example 7. The computer system 100 of any one of examples 1-6, wherein the predetermined range 222 is a time gap or a distance.

Example 8. The computer system 100 of any one of examples 1-7, wherein the processing circuitry 110 is configured to, for each of the trailing vehicles 30: request a propulsion mode 33 of the trailing vehicle 30, and responsive to the associated request timing out, determine that the trailing vehicle 30 is not operating in a mode corresponding to the topography fuel efficiency mode.

Example 9. The computer system 100 of example 8, wherein the request for the propulsion mode 33 is provided across a vehicle-to-vehicle communications interface 210.

Example 10. The computer system 100 of example 9 wherein the vehicle-to-vehicle communications interface 210 is a direct interface between at least the vehicle 10 and one of the one or more trailing vehicles 30.

Example 11. The computer system 100 of example 9, wherein the vehicle-to-vehicle communications interface 210 is a cloud interface.

Example 12. The computer system 100 of any one of examples 3-11, wherein the processing circuitry 110 is further configured to: obtain speed limit data of the current road segment 25; and configure the configurable speed deviation 234 based on the speed limit data.

Example 13. The computer system 100 of example 1 wherein the target speed range 232 of the vehicle 10 is a range comprising a speed limit 236 of a current road segment 25; the processing circuitry 110 is further configured to: permit the current speed 242 of the vehicle 10 to deviate below the target speed range 232 of the vehicle 10 by a configurable speed deviation 234; the processing circuitry 110 is further configured to: responsive to the topography data 27 indicating a change in slope 212 of the upcoming road segment 21, 22, configure the configurable speed deviation 234 based on an estimate a travel time for the vehicle 10 to reach the road segment associated with the change in slope 212 indicated by the topography data 27; the processing circuitry 110 is further configured to: configure the configurable speed deviation 234 based on a geographical location of the vehicle 10; the processing circuitry 110 is further configured to: configure the configurable speed deviation 234 based on additional vehicle data 19, additional trailing vehicle data 39 and/or environment data 79; the predetermined range 222 is a time gap or a distance; the processing circuitry 110 is configured to, for each of the trailing vehicles 30: request the propulsion mode 33 of the trailing vehicle 30, and responsive to the associated request timing out, determine that the trailing vehicle 30 is not operating in a mode corresponding to the topography fuel efficiency mode; the request the propulsion mode 33 is provided across a vehicle-to-vehicle communications interface 210; the vehicle-to-vehicle communications interface 210 is a direct interface between at least the vehicle 10 and one of the one or more trailing vehicles 30 or the vehicle-to-vehicle communications interface 210 is a cloud interface; and the processing circuitry 110 is further configured to: obtain speed limit data of the current road segment 25; and configure the configurable speed deviation 234 based on the speed limit data.

Example 14. A vehicle 10 comprising the computer system 100 of any one of examples 1-13.

Example 15. The vehicle 10 of example 14 wherein the vehicle 10 is a heavy-duty vehicle.

Example 16. A computer-implemented method 300 comprising: evaluating 310, by a processing circuitry 110 of a computer system 100, based on topography data 27 of an upcoming road segment 21, 22, use of upcoming topography to achieve a target speed range 232 of a vehicle 10 operating in a topography fuel efficiency mode; determining 320 all trailing vehicles within a predetermined range 222 are operating in a propulsion mode 33 corresponding to the topography fuel efficiency mode; responsive to determining that all trailing vehicles 30 within the predetermined range 222 are operating in a propulsion mode 33 corresponding to the topography fuel efficiency mode: permitting 350, by the processing circuitry 110 of the computer system 100, a current speed 242 of the vehicle 10 to temporarily deviate below the target speed range 232 of the vehicle 10 and to use the upcoming topography to achieve the target speed 232.

Example 17. The computer-implemented method 300 of example 16, wherein the target speed range 232 of the vehicle 10 is a range comprising a speed limit 236 of a current road segment 25.

Example 18. The computer-implemented method 300 of example 16 or 17, further comprising: permitting 350, by the processing circuitry 110 of the computer system 100, the current speed 242 of the vehicle 10 to deviate below the target speed range 232 of the vehicle by a configurable speed deviation 234.

Example 19. The computer-implemented method 300 of example 18, further comprising: responsive to the topography data 27 indicating a change in slope 212 of the upcoming road segment 21, 22, configuring 330, by the processing circuitry 110 of the computer system 100, the configurable speed deviation 234 based on an estimate a travel time for the vehicle 10 to reach the road segment associated with the change in slope 212 indicated by the topography data 27.

Example 20. The computer-implemented method 300 of example 18 or 19, further comprising: configuring 330, by the processing circuitry 110 of the computer system 100, the configurable speed deviation 234 based on a geographical location of the vehicle 10.

Example 21. The computer-implemented method 300 of any one of examples 16 to 20, further comprising: configuring 330, by the processing circuitry 110 of the computer system 100, the configurable speed deviation 234 based on additional vehicle data 19, additional trailing vehicle data 39 and/or additional environment data 79.

Example 22. The computer-implemented method 300 of any one of examples 16 to 21, wherein the predetermined range 222 is a time gap or a distance.

Example 23. The computer-implemented method 300 of any one of examples 16 to 22, further comprising: requesting 340, by the processing circuitry 110 of the computer system 100, an indication of a propulsion mode 33 of the trailing vehicle 30, responsive to the propulsion mode 33 of the trailing vehicle 30 corresponding to the topography fuel efficiency mode, determining, by the processing circuitry 110 of the computer system 100, that the trailing vehicle 30 is operating in a propulsion mode 33 corresponding to the topography fuel efficiency mode, and responsive to the associated request for an indication timing out, determining, by the processing circuitry 110 of the computer system 100, that the trailing vehicle 30 is not operating in a propulsion mode 33 corresponding to the topography fuel efficiency mode.

Example 24. The computer-implemented method 300 of example 23, wherein the request for the indication of a propulsion mode 33 is provided across a vehicle-to-vehicle communications interface 210.

Example 25. The computer-implemented method 300 of example 24, wherein the vehicle-to-vehicle communications interface 210 is a direct interface between at least the vehicle 10 and one of the one or more trailing vehicles 30.

Example 26. The computer-implemented method 300 of example 24, wherein the vehicle-to-vehicle communications interface 210 is a cloud interface.

Example 27. The computer-implemented method 300 of any one of examples 18 to 26, further comprising: obtaining, by the processing circuitry 110 of the computer system 100, speed limit data of the current road segment 25; and configuring 330, by the processing circuitry 110 of the computer system 100, the configurable speed deviation 234 based on the speed limit data.

Example 28. A computer program product 400 comprising program code 610 for performing, when executed by the processing circuitry 110, the method 300 of any of examples 16 to 27.

Example 29. A non-transitory computer-readable storage medium 500 comprising instructions 510, which when executed by the processing circuitry 110, cause the processing circuitry 110 to perform the method 300 of any of examples 16 to 27.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A computer system comprising processing circuitry configured to:
evaluate, based on topography data of an upcoming road segment, use of upcoming topography to achieve a target speed range of a vehicle operating in a topography fuel efficiency mode;
determine all trailing vehicles within a predetermined range are operating in a propulsion mode corresponding to the topography fuel efficiency mode;
responsive to determining that all trailing vehicles within the predetermined range are operating in the propulsion mode corresponding to the topography fuel efficiency mode:
permit a current speed of the vehicle to temporarily deviate below the target speed range of the vehicle and to use the upcoming topography to achieve the target speed range.

2. The computer system of claim 1, wherein the target speed range of the vehicle comprises a speed limit of a current road segment.

3. The computer system of claim 1, wherein the processing circuitry is further configured to:
permit the current speed of the vehicle to deviate below the target speed range of the vehicle by a configurable speed deviation.

4. The computer system of claim 3, wherein the processing circuitry is further configured to:
responsive to the topography data indicating a change in slope of the upcoming road segment, configure the configurable speed deviation based on a travel time estimate for the vehicle to reach the road segment associated with the change in slope indicated by the topography data.

5. The computer system of claim 3, wherein the processing circuitry is further configured to:
configure the configurable speed deviation based on a geographical location of the vehicle.

6. The computer system of claim 3, wherein the processing circuitry is further configured to:
configure the configurable speed deviation based on additional vehicle data,
additional trailing vehicle data and/or environment data.

7. The computer system of claim 1, wherein the predetermined range is a time gap or a distance.

8. The computer system of claim 1, wherein the processing circuitry is configured to, for each of the trailing vehicles:
request the propulsion mode of the trailing vehicle, and
responsive to the associated request timing out, determine that the trailing vehicle is
not operating in a mode corresponding to the topography fuel efficiency mode.

9. The computer system of claim 8, wherein the request the propulsion mode is provided across a vehicle-to-vehicle communications interface.

10. The computer system of claim 3, wherein the processing circuitry is further configured to:
obtain speed limit data of the current road segment; and
configure the configurable speed deviation based on the speed limit data.

11. The computer system of claim 1, wherein the target speed range of the vehicle is a range comprising a speed limit of a current road segment; the processing circuitry is further configured to: permit the current speed of the vehicle to deviate below the target speed range of the vehicle by a configurable speed deviation; the processing circuitry is further configured to: responsive to the topography data indicating a change in slope of the upcoming road segment, configure the configurable speed deviation based on an estimate a travel time for the vehicle to reach the road segment associated with the change in slope indicated by the topography data; the processing circuitry is further configured to: configure the configurable speed deviation based on a geographical location of the vehicle; the processing circuitry is further configured to: configure the configurable speed deviation based on additional vehicle data, additional trailing vehicle data and/or environment data; the predetermined range is a time gap or a distance; the processing circuitry is configured to, for each of the trailing vehicles: request the propulsion mode of the trailing vehicle, and responsive to the associated request timing out, determine that the trailing vehicle is not operating in a mode corresponding to the topography fuel efficiency mode; the request for the propulsion mode is provided across a vehicle-to-vehicle communications interface; the vehicle-to-vehicle communications interface is a direct interface between at least the vehicle and one of the one or more trailing vehicles or the vehicle-to-vehicle communications interface is a cloud interface; and the processing circuitry is further configured to: obtain speed limit data of the current road segment; and configure the configurable speed deviation based on the speed limit data.

12. A vehicle comprising the computer system of claim 1.

13. A computer-implemented method comprising:
evaluating, by a processing circuitry of a computer system, based on topography data of an upcoming road segment, use of upcoming topography to achieve a target speed range of a vehicle operating in a topography fuel efficiency mode;
determining all trailing vehicles within a predetermined range are operating in a propulsion mode corresponding to the topography fuel efficiency mode;
responsive to determining that all trailing vehicles within a predetermined range are operating in a propulsion mode corresponding to the topography fuel efficiency mode:
permitting, by the processing circuitry of the computer system, a current speed of the vehicle to temporarily deviate below the target speed range of the vehicle and to use the upcoming topography to achieve the target speed.

14. The computer-implemented method of claim 13, wherein the target speed range of the vehicle is a range comprising a speed limit of a current road segment.

15. The computer-implemented method of claim 13, further comprising: permitting, by the processing circuitry of the computer system, the current speed of the vehicle to deviate below the target speed range of the vehicle by a configurable speed deviation.

16. The computer-implemented method of claim 15, further comprising: responsive to the topography data indicating a change in slope of the upcoming road segment, configuring, by the processing circuitry of the computer system, the configurable speed deviation based on an estimate a travel time for the vehicle to reach the road segment associated with the change in slope indicated by the topography data.

17. The computer-implemented method of claim 15, further comprising: configuring, by the processing circuitry of the computer system, the configurable speed deviation based on a geographical location of the vehicle.

18. The computer-implemented method of claim 13, further comprising: configuring, by the processing circuitry of the computer system, the configurable speed deviation based on additional vehicle data, additional trailing vehicle data and/or additional environment data.

19. A computer program product comprising program code for performing, when executed by the processing circuitry, the method of claim 13.

20. A non-transitory computer-readable storage medium comprising instructions, which when executed by the processing circuitry, cause the processing circuitry to perform the method of claim 13.
